(19) United States
(12) Patent Application Publication
(10) Pub. No.: US 2025/0148046 A1
(43) Pub. Date: May 8, 2025

(54) METHOD OF GENERATING FFT VALUE AND ELECTRONIC DEVICE FOR PERFORMING THE METHOD

(71) Applicant: SAMSUNG ELECTRONICS CO., LTD., SUWON-SI (KR)

(72) Inventors: KIHA KIM, Suwon-si (KR); DONGJIN LEE, Suwon-si (KR); JUNHWAN LEE, Suwon-si (KR); YONGDEOK KIM, Suwon-si (KR); GEUNTAE BAE, Suwon-si (KR)

(21) Appl. No.: 18/830,101

(22) Filed: Sep. 10, 2024

(30) Foreign Application Priority Data
Nov. 2, 2023 (KR) 10-2023-0149876

(51) Int. Cl. G06F 17/14

(52) U.S. Cl. CPC G06F 17/142

(57) ABSTRACT

A method of performing a fast Fourier transform (FFT) operation for a plurality of input values includes generating a plurality of sub-input data sets based on a plurality of input values, each having an index in a first dimension and an index in a second dimension, calculating a plurality of intermediate values by performing an FFT on each of the plurality of sub-input data sets, calculating partial FFT values for the plurality of input values based on the plurality of intermediate values, and generating a plurality of FFT value sets for the plurality of input values based on the partial FFT values.

### CROSS-REFERENCE TO RELATED APPLICATIONS

This application claims priority under 35 U.S.C. § 119 from Korean Patent Application No. 10-2023-0149876, filed on Nov. 2, 2023 in the Korean Intellectual Property Office, the contents of which are herein incorporated by reference in their entirety.

### TECHNICAL FIELD

One or more embodiments are directed to technology that generates fast Fourier transform (FFT) values for input values, and more particularly, to technology that generates FFT values for multi-dimensional input values.

### DISCUSSION OF THE RELATED ART

The multi-dimensional fast Fourier transform (FFT) is used in various fields, such as image processing, audio signal processing, radar signal processing, sonar signal processing, video compression, or climate modeling. For example, an FFT can be used in a computational fluid dynamics (CFD) simulation in a semiconductor manufacturing process. For example, an FFT can be used in a density-functional theory (DFT) simulation of an electronic structure that calculates properties of a semiconductor at the quantum level.

### SUMMARY

According to an embodiment, there is provided a method, performed by an electronic device, of generating fast Fourier transform (FFT) values for a plurality of multi-dimensional input values, the method including generating a plurality of sub-input data sets by classifying a plurality of input values, each having an index in a first dimension and an index in a second dimension, based on an even index in the first dimension, an odd index in the first dimension, an even index in the second dimension, and an odd index in the second dimension. The plurality of sub-input data sets includes a first sub-input data set that includes input values of the plurality of input values that have an even index in the first dimension and an even index in the second dimension, a second sub-input data set that includes input values of the plurality of input values that have an odd index in the first dimension and an even index in the second dimension, a third sub-input data set that includes input values of the plurality of input values that have an even index in the first dimension and an odd index in the second dimension, and a fourth sub-input data set that includes input values of the plurality of input values that have an odd index in the first dimension and an odd index in the second dimension, calculating a first intermediate value by performing an FFT on the first sub-input data set, calculating a second intermediate value by performing an FFT on the second sub-input data set, calculating a third intermediate value by performing an FFT on the third sub-input data set, calculating a fourth intermediate value by performing an FFT on the fourth sub-input data set, calculating a first value for the plurality of input values based on the first intermediate value, calculating a second value for the plurality of input values based on the second intermediate value, calculating a third value for the plurality of input values based on the third intermediate value, calculating a fourth value for the plurality of input values based on the fourth intermediate value, and generating a plurality of FFT value sets for the plurality of input values based on the first value, the second value, the third value, and the fourth value.

Generating the plurality of sub-input data sets may include arranging the first sub-input data set in a first dimension in a memory of the electronic device through all-to-all communication.

The plurality of input values may be stored in a plurality of distributed memories of the electronic device, and the memory may be one of the plurality of distributed memories.

The first intermediate value, the second intermediate value, the third intermediate value, and the fourth intermediate value may be calculated through a first pipeline, a second pipeline, a third pipeline, and a fourth pipeline, respectively.

Calculating the first intermediate value by performing the FFT on the first sub-input data set may include calculating a first partial value by performing a primary FFT on the first sub-input data set and calculating the first intermediate value by performing a secondary FFT on the first partial value.

Calculating the first intermediate value by performing the FFT on the first sub-input data set may further include arranging the first partial value in a second dimension in a memory of the electronic device through all-to-all communication.

Calculating the first intermediate value by performing the secondary FFT on the first partial value may include calculating the first intermediate value by performing the secondary FFT on the first partial value arranged in the second dimension in the memory of the electronic device.

Generating the plurality of FFT value sets for the plurality of input values based on the first value, the second value, the third value, and the fourth value may include generating a first FFT value set of the plurality of FFT value sets by summing the first value, the second value, the third value, and the fourth value.

Generating of the plurality of FFT value sets for the plurality of input values based on the first value, the second value, the third value, and the fourth value may include generating a second FFT value set of the plurality of FFT value sets by summing the first value, a negative value of the second value, the third value, and a negative value of the fourth value.

Generating the plurality of FFT value sets for the plurality of input values based on the first value, the second value, the third value, and the fourth value may include generating a third FFT value set of the plurality of FFT value sets by summing the first value, the second value, a negative value of the third value, and a negative value of the fourth value.

Generating the plurality of FFT value sets for the plurality of input values based on the first value, the second value, the third value, and the fourth value may include generating a fourth FFT value set of the plurality of FFT value sets by summing the first value, a negative value of the second value, a negative value of the third value, and the fourth value.

According to another embodiment, there is provided an electronic device that includes a processor and a memory. The processor is configured to generate a plurality of sub-input data sets by classifying a plurality of input values, each having an index in a first dimension and an index in a second dimension, based on an even index in the first dimension, an odd index in the first dimension, an even index in the second dimension, and an odd index in the second dimension. The plurality of sub-input data sets includes a first sub-input data set that includes input values of the plurality of input values that have an even index in the first dimension and an even index in the second dimension, a second sub-input data set that includes input values of the plurality of input values that have an odd index in the first dimension and an even index in the second dimension, a third sub-input data set that includes input values of the plurality of input values that have an even index in the first dimension and an odd index in the second dimension, and a fourth sub-input data set that include input values of the plurality of input values that have an odd index in the first dimension and an odd index in the second dimension, calculate a first intermediate value by performing an FFT on the first sub-input data set, calculate a second intermediate value by performing an FFT on the second sub-input data set, calculate a third intermediate value by performing an FFT on the third sub-input data set, calculate a fourth intermediate value by performing an FFT on the fourth sub-input data set, calculate a first value, a second value, a third value, and a fourth value for the plurality of input values based on the first intermediate value, the second intermediate value, the third intermediate value, and the fourth intermediate value, and generate a plurality of FFT value sets for the plurality of input values based on the first value, the second value, the third value, and the fourth value.

The processor may be configured to arrange the first sub-input data set in a first dimension in the memory of the electronic device through all-to-all communication.

The memory may be one of a plurality of distributed memories, and the plurality of input values may be stored in the plurality of distributed memories of the electronic device.

The processor may be configured to calculate a first partial value by performing a primary FFT on the first sub-input data set and calculate the first intermediate value by performing a secondary FFT on the first partial value.

The processor may be further configured to arrange the first partial value in the second dimension in the memory of the electronic device through all-to-all communication.

The processor may be further configured to calculate the first intermediate value by performing the secondary FFT on the first partial value arranged in the second dimension in the memory of the electronic device.

The processor may be configured to generate a first FFT value set of the plurality of FFT value sets by summing the first value, the second value, the third value, and the fourth value.

The processor may be configured to generate a second FFT value set of the plurality of FFT value sets by summing the first value, a negative value of the second value, the third value, and a negative value of the fourth value.

The processor may be configured to generate a third FFT value set of the plurality of FFT value sets by summing the first value, the second value, a negative value of the third value, and a negative value of the fourth value.

The processor may be configured to generate a fourth FFT value set of the plurality of FFT value sets by summing the first value, a negative value of the second value, a negative value of the third value, and the fourth value.

According to another embodiment, there is provided a method, performed by an electronic device, of generating fast Fourier transform (FFT) values for a plurality of multi-dimensional input values, the method including generating a plurality of sub-input data sets by classifying a plurality of input values, each having an index in a first dimension and an index in a second dimension, based on an even index in the first dimension, an odd index in the first dimension, an even index in the second dimension, and an odd index in the second dimension, wherein the plurality of sub-input data sets comprises a first sub-input data set, a second sub-input data set, a third sub-input data set, and a fourth sub-input data set; calculating a first intermediate value by performing an FFT on the first sub-input data set; calculating a second intermediate value by performing an FFT on the second sub-input data set; calculating a third intermediate value by performing an FFT on the third sub-input data set; calculating a fourth intermediate value by performing an FFT on the fourth sub-input data set; calculating a first value for the plurality of input values based on the first intermediate value; calculating a second value for the plurality of input values based on the second intermediate value; calculating a third value for the plurality of input values based on the third intermediate value; calculating a fourth value for the plurality of input values based on the fourth intermediate value; and generating a plurality of FFT value sets for the plurality of input values based on the first value, the second value, the third value, and the fourth value. The first intermediate value, the second intermediate value, the third intermediate value, and the fourth intermediate value are calculated through a first pipeline, a second pipeline, a third pipeline, and a fourth pipeline, respectively.

The first sub-input data set may include input values of the plurality of input values that have an even index in the first dimension and an even index in the second dimension, the second sub-input data set may include input values of the plurality of input values that have an odd index in the first dimension and an even index in the second dimension, the third sub-input data set may include input values of the plurality of input values that have an even index in the first dimension and an odd index in the second dimension, and the fourth sub-input data set may include input values of the plurality of input values that have an odd index in the first dimension and an odd index in the second dimension.

Additional aspects of embodiments will be set forth in part in the description which follows and, in part, will be apparent from the description, or may be learned by practice of the disclosure.

### BRIEF DESCRIPTION OF THE DRAWINGS

FIG. 1 illustrates a method of generating a plurality of fast Fourier transform (FFT) value sets by processing multi-dimensional input values using a plurality of pipelines, according to an embodiment.

FIG. 2 illustrates an electronic device according to an embodiment.

FIG. 3 is a flowchart of a method of generating a plurality of FFT value sets for multi-dimensional input values, according to an embodiment.

FIG. 4 is a flowchart of a method of calculating a first intermediate value of a first sub-input data set, according to an embodiment.

### DETAILED DESCRIPTION

Hereinafter, embodiments will be described in detail with reference to the accompanying drawings. However, various alterations and modifications may be made to the embodiments. However, embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals may refer to like components and a repeated description related thereto may be omitted.

Also, in the description of the components, terms such as first, second, A, B, (a), (b) or the like may be used herein when describing components of the present disclosure. These terms are used only for the purpose of discriminating one component from another component, and the nature, the sequences, or the orders of the components are not limited by the terms. It should be noted that if one component is described as being “connected,” “coupled” or “joined” to another component, the former may be directly “connected,” “coupled,” and “joined” to the latter or “connected”, “coupled”, and “joined” to the latter via another component.

Components included in one embodiment and components having a common function will be described using the same names in other embodiments. Unless otherwise mentioned, the descriptions of the embodiments may be applicable to the following embodiments and thus, duplicated descriptions will be omitted for conciseness.

In general, a periodic function may be expressed by expanding the periodic function into a series based on a sine and cosine functions, and the series is referred to as a Fourier series. A coefficient corresponding to K, which is a wave number of each term of the Fourier series, is known through a Fourier transform. Calculating a Fourier coefficient discretely is referred to as a discrete Fourier transfer. When the number of inputs (or samples) is N, the calculation cost for the discrete Fourier transfer is N², so the calculation cost for the discrete Fourier transfer increases rapidly when N increases. An algorithm for addressing the rapid increase of the calculation is a fast Fourier transform (FFT). An FFT operation on an input x can be expressed by Equations 1 and 2 below.

$$\hat{f} ( {κ}_{i} ) = {\sum }_{j = 0}^{N - 1} f ( {x}_{j} ) {ω}^{i j} , ω ≡ {e}^{i \frac{2 π}{N}} \qquad Equation l$$

$$\hat{f} ( κ ) = ℱ f ( x ) ,$$

$$x = [ \begin{matrix}{x}_{0} \\ {x}_{1} \\ ⋮ \\ \\ \\ \\ ⋮ \\ {x}_{N - 1}\end{matrix} ] κ = [ \begin{matrix}{κ}_{a} \\ {κ}_{1} \\ ⋮ \\ \\ \\ \\ ⋮ \\ {κ}_{N - 1}\end{matrix} ] \qquad Equation 2$$

For example, when N is 8, [symbol] in Equation 2 may be expressed as a matrix in Table 1 below.

TABLE 1

| 1 | 1 | 1 | 1 | 1 | 1 | 1 | 1 |
|---|---|---|---|---|---|---|---|
| 1 | ω¹ | ω² | ω³ | ω⁴ | ω⁵ | ω⁶ | ω⁷ |
| 1 | ω² | ω⁴ | ω⁶ | ω⁴ | ω¹⁰ | ω¹² | ω¹⁴ |
| 1 | ω³ | ω⁶ | ω⁹ | ω¹² | ω¹⁵ | ω¹⁸ | ω²¹ |
| 1 | ω⁴ | ω⁸ | ω¹² | ω¹⁶ | ω²⁰ | ω²⁴ | ω²⁸ |
| 1 | ω⁵ | ω¹⁰ | ω¹⁵ | ω²⁰ | ω²⁵ | ω³⁰ | ω³⁵ |
| 1 | ω⁶ | ω¹² | ω¹⁸ | ω²⁴ | ω³⁰ | ω³⁶ | ω⁴² |
| 1 | ω⁷ | ω¹⁴ | ω²¹ | ω²⁸ | ω³⁵ | ω⁴² | ω⁴⁹ |

According to an embodiment, the Cooley-Tukey algorithm can further reduce the number of calculations of the FFT. The Cooley-Tukey algorithm divides the input x into an even-numbered input xe and an odd-numbered input xo in the discrete Fourier transfer task in which the number of inputs x is N. The result of an FFT operation corresponding to a first half κa={κ₀, κ₁, . . . , κ_{N/2-1}} and a second half κb={κ_{N/2}, κ_{N/2+1}, . . . , κ_{N-1}} in the wave number κ can be expressed as an operation on a reduced matrix F and an operation on a diagonal matrix D. The result of the FFT operation on the input x using the Cooley-Tukey algorithm can be expressed by Equation 3 below.

$$[ \begin{matrix}\hat{f} ( κ a ) \\ \hat{f} ( κ b )\end{matrix} ] = [ \begin{matrix}I & D \\ I & − D\end{matrix} ] [ \begin{matrix}F & 0 \\ 0 & F\end{matrix} ] [ \begin{matrix}f ( x e ) \\ f ( x o )\end{matrix} ] ,$$

$$x = \text{} [ \begin{matrix}{x}_{0} \\ {x}_{1} \\ ⋮ \\ \\ \\ \\ ⋮ \\ {x}_{N - 1}\end{matrix} ] = [ \begin{matrix}[ \begin{matrix}{x}_{0} \\ {x}_{2} \\ ⋮ \\ \end{matrix} ] \\ [ \begin{matrix}\begin{matrix}{x}_{1} \\ {x}_{3}\end{matrix} \\ ⋮ \\ \end{matrix} ]\end{matrix} ] = [ \begin{matrix}[ \begin{matrix}{xe}_{0} \\ {xe}_{1} \\ ⋮ \\ \end{matrix} ] \\ [ \begin{matrix}\begin{matrix}{xo}_{0} \\ {xo}_{1}\end{matrix} \\ ⋮ \\ \end{matrix} ]\end{matrix} ] = [ \begin{matrix}xe \\ xo\end{matrix} ] ,$$

$$κ = [ \begin{matrix}{κ}_{a} \\ {κ}_{1} \\ ⋮ \\ \\ \\ \\ ⋮ \\ {κ}_{N - 1}\end{matrix} ] = [ \begin{matrix}[ \begin{matrix}{κ}_{0} \\ {κ}_{1} \\ ⋮ \\ {κ}_{N / 2 - 1}\end{matrix} ] \\ [ \begin{matrix}\begin{matrix}{κ}_{0 + N / 2} \\ {κ}_{1 + N / 2}\end{matrix} \\ ⋮ \\ {κ}_{N - 1}\end{matrix} ]\end{matrix} ] = [ \begin{matrix}[ \begin{matrix}κ {a}_{0} \\ κ {a}_{1} \\ ⋮ \\ κ {a}_{N / 2 - 1}\end{matrix} ] \\ [ \begin{matrix}\begin{matrix}κ {b}_{0} \\ κ {b}_{1}\end{matrix} \\ ⋮ \\ κ {b}_{N / 2 - 1}\end{matrix} ]\end{matrix} ] = [ \begin{matrix}κ a \\ k b\end{matrix} ]$$

For example, when N is 8, I, D, and Fin Equation 3 can be expressed as matrixes in Table 2, Table 3, and Table 4 below, respectively.

TABLE 2
$I = ( \begin{matrix}1 & 0 & 0 & 0 \\ 0 & 1 & 0 & 0 \\ 0 & 0 & 1 & 0 \\ 0 & 0 & 0 & 1\end{matrix} )$

TABLE 3
$D = ( \begin{matrix}1 & 0 & 0 & 0 \\ 0 & {ω}^{1} & 0 & 0 \\ 0 & 0 & {ω}^{2} & 0 \\ 0 & 0 & 0 & {ω}^{3}\end{matrix} )$

TABLE 4
$F = ( \begin{matrix}1 & 1 & 1 & 1 \\ 1 & {ω}^{2} & {ω}^{4} & {ω}^{6} \\ 1 & {ω}^{4} & {ω}^{8} & {ω}^{12} \\ 1 & {ω}^{6} & {ω}^{12} & {ω}^{18}\end{matrix} )$

According to an embodiment, the Cooley-Tukey algorithm can be recursively applied to the operation on the reduced matrix F. Finally, the number of calculations for the FFT is reduced from N² to N log N.

According to an embodiment, an FFT operation on multi-dimensional inputs x and y includes performing the FFT on the input x and then performing the FFT on the input y. The FFT operation on the multi-dimensional inputs x and y can be expressed by Equation 4 below.

$$\tilde{f} ( κ , λ ) = 𝒢ℱ f ( x , y ) \qquad Equation 4$$

$$\tilde{f} ( κ , y ) = [ \begin{matrix}f ( 𝓀 a , y ) \\ f ( 𝓀 b , y )\end{matrix} ] = [ \begin{matrix}I & D \\ I & − D\end{matrix} ] [ \begin{matrix}F & 0 \\ 0 & F\end{matrix} ] [ \begin{matrix}f ( xe , y ) \\ f ( xo , y )\end{matrix} ]$$

$$\tilde{f} ( κ , λ ) = \begin{matrix}f ( κ , λ a ) \\ f ( κ , λ b )\end{matrix} ] = [ \begin{matrix}I & d \\ I & − d\end{matrix} ] [ \begin{matrix}G & 0 \\ 0 & G\end{matrix} ] [ \begin{matrix}\hat{f} ( κ , y e ) \\ \hat{f} ( κ , yo )\end{matrix} ]$$

In Equation 4, the wave number κ and a wave number λ respectively correspond to the input x and the input y. N inputs x are divided into the even-numbered input xe and the odd-numbered input xo. κa={κ₀, κ₁, . . . , κ_{N/2-1}} and κb={κ_{N/2}, κ_{N/2+1}, . . . , κ_{N-1}}). M inputs y can be divided into an even-numbered input ye and an odd-numbered input yo. λa={λ₀, λ₁, . . . , λ_{M/2-1}} and λb={λ_{M/2}, λ_{M/2+1}, . . . , λ_{M-1}}. In an FFT operation on the input y, a matrix G and a matrix d respectively correspond to the reduced matrix F and the diagonal matrix D of the FFT operation on the input x.

In the above-described Cooley-Tukey algorithm, since the recursive calculation is performed in each dimension of an input, an FFT operation is performed on the input y after an FFT operation is completed on the input x. Accordingly, in an FFT operation on an input with more than two dimensions, an FFT operation on one dimension of the input is completed before an FFT operation on the next dimension is performed, so there may be a “calculation dependency between dimensions.”

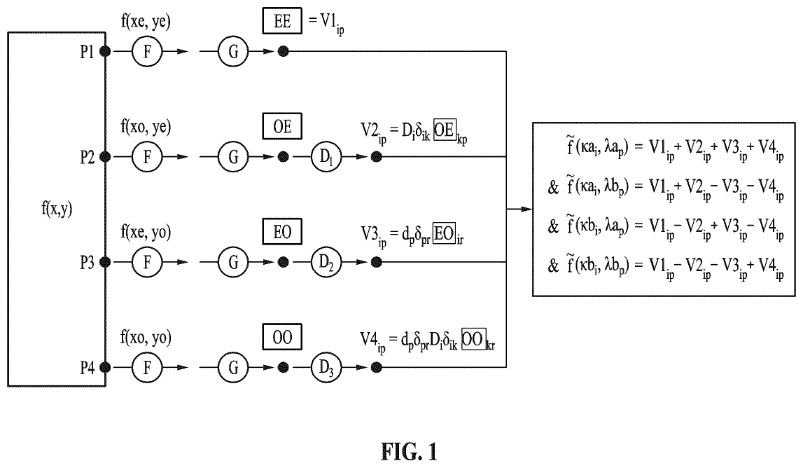

In an FFT operation on the multi-dimensional input, the “calculation dependency between dimensions” causes the following problems in an computer system with distributed memories. First, since data should be arranged in memory in a dimension of an input being recursively operated on, all-to-all communication is required. Second, since the FFT operation on one dimension of the input is completed before the FFT operation on the next dimension is performed, overlap between data communications may be impossible. A method of performing an FFT operation on the multi-dimensional input by overlapping data communications in an computer system with distributed memories is described in detail below with reference to FIGS. 1 to 4.

FIG. 1 illustrates a method of generating a plurality of FFT value sets by processing multi-

dimensional input values using a plurality of pipelines, according to an embodiment.

According to an embodiment, to avoid the “calculation dependency between dimensions,” a plurality of sub-input data sets are generated by classifying the entire multi-dimensional input value into an even-numbered input and an odd-numbered input for each dimension of input values. The sub-input data sets include the entire input value. For example, when the entire input value has two dimensions, x and y, the plurality of sub-input data sets include a first sub-input data set that includes the even-numbered input xe in an x dimension and the even-numbered input ye in a y dimension, a second sub-input data set that includes the odd-numbered input xo in the x dimension and the even-numbered input ye in the y dimension, a third sub-input data set that includes the even-numbered input xe in the x dimension and the odd-numbered input yo in the y dimension, and a fourth sub-input data set that includes the odd-numbered input xo in the x dimension and the odd-numbered input yo in the y dimension. For example, when the entire input value has three dimensions, x, y, and z, a total of eight sub-input data sets are generated for the entire input value. Whether an input in a certain dimension is an even-numbered input or an odd-numbered input can be determined based on an index of the input in the corresponding dimension. For example, x₀ and x₂ are even-numbered inputs in the x dimension. For example, y₁ and y₃ are odd-numbered inputs in the y dimension.

The result of performing the FFT operation on \tilde{f}(κ, λ)= [symbol] f(x, y) in the y dimension after performing the FFT operation on \tilde{f}(κ, λ)= [symbol] f(x, y) in the x dimension described above in Equation 4 can be expressed by Equation 5 below.

$$\tilde{f} ( κ , λ ) = 𝒢ℱ f ( x , y ) \qquad Equation 5$$

$$\hat{f} ( κ , y ) = ℱ f ( x , y ) = [ \begin{matrix}\hat{f} ( κ a , y ) \\ \hat{f} ( κ b , y )\end{matrix} ] [ \begin{matrix}I & D \\ I & - D\end{matrix} ] [ \begin{matrix}F & 0 \\ 0 & F\end{matrix} ] [ \begin{matrix}( xe , y ) \\ ( xo , y )\end{matrix} ]$$

$$\hat{f} ( κ {a}_{i} , y ) = {F}_{ij} f ( x {e}_{i} , y ) + \text{} {D}_{i} \text{} {δ}_{i k} \text{} {F}_{kj} \text{} f ( x {o}_{j} , y ) \to \text{} \{ \begin{matrix}\hat{f} ( κ {a}_{i} , y {e}_{q} ) = \{ {F}_{ij} f ( x {e}_{j} , y {e}_{q} ) + {D}_{i} {δ}_{i k} {F}_{kj} f ( x {o}_{j} , y {e}_{q} ) \} \\ \hat{f} ( κ {a}_{i} , y {o}_{q} ) = \{ {F}_{ij} f ( x {e}_{j} , y {o}_{q} ) + {D}_{i} {δ}_{i k} {F}_{kj} f ( x {o}_{j} , y {o}_{q} ) \}\end{matrix}$$

$$\hat{f} ( κ {b}_{i} , y ) = {F}_{ij} f ( x {e}_{i} , y ) − {D}_{i} {δ}_{i k} {F}_{kj} f ( {xo}_{j} , y ) \to \{ \begin{matrix}\hat{f} ( κ b , {ye}_{q} ) = \{ {F}_{ij} f ( x {e}_{j} , y {e}_{q} ) − {D}_{i} {δ}_{i k} {F}_{kj} f ( x {o}_{j} , y {e}_{q} ) \} \\ \hat{f} ( κ {b}_{i} , y {o}_{q} ) = \{ {F}_{ij} f ( x {e}_{j} , y {o}_{q} ) − {D}_{i} {δ}_{i k} {F}_{kj} f ( x {o}_{j} , y {o}_{q} ) \}\end{matrix}$$

$$\tilde{f} ( κ , λ ) = g \hat{f} ( κ , y ) = [ \begin{matrix}\tilde{f} ( κ , λ a ) \\ \tilde{f} ( κ , λ b )\end{matrix} ] = [ \begin{matrix}I & d \\ I & − d\end{matrix} ] [ \begin{matrix}G & 0 \\ 0 & G\end{matrix} ] [ \begin{matrix}\hat{f} ( κ , ye ) \\ \hat{f} ( κ , y o )\end{matrix} ]$$

$$\tilde{f} ( κ , λ {a}_{p} ) = {G}_{p q} \tilde{f} ( κ , y {e}_{q} ) + {d}_{p} {δ}_{p r} {G}_{r q} \hat{f} ( κ , y {o}_{q} ) \to \{ \begin{matrix}\tilde{f} ( κ {a}_{i} , λ {a}_{p} ) = {G}_{p q} \hat{f} ( κ {a}_{i} , y {e}_{q} ) + {d}_{p} {δ}_{p r} {G}_{r q} \hat{f} ( κ {a}_{i} , y {o}_{q} ) \\ \tilde{f} ( κ {b}_{i} , λ {a}_{p} ) = {G}_{p q} \hat{f} ( κ {b}_{i} , y {e}_{q} ) + {d}_{p} {δ}_{p r} {G}_{r q} \hat{f} ( κ {b}_{i} , y {o}_{q} )\end{matrix}$$

$$\tilde{f} ( κ , λ {b}_{p} ) = {G}_{p q} \tilde{f} ( κ , y {e}_{q} ) − {d}_{p} {δ}_{p r} {G}_{r q} \hat{f} ( κ , y {o}_{q} ) \to \{ \begin{matrix}\tilde{f} ( κ {a}_{i} , λ {b}_{p} ) = {G}_{p q} \hat{f} ( κ {a}_{i} , y {e}_{q} ) − {d}_{p} {δ}_{p r} {G}_{r q} \hat{f} ( κ {a}_{i} , y {o}_{q} ) \\ \tilde{f} ( κ {b}_{i} , λ {b}_{p} ) = {G}_{p q} \hat{f} ( κ {b}_{i} , y {e}_{q} ) − {d}_{p} {δ}_{p r} {G}_{r q} \hat{f} ( κ {b}_{i} , y {o}_{q} )\end{matrix}$$

$$\tilde{f} ( κ {a}_{i} , λ {a}_{p} ) = {G}_{p q} \{ {F}_{ij} f ( x {e}_{j} , y {e}_{q} ) + {D}_{i} {δ}_{i k} {F}_{kj} f ( x {o}_{j} , y {e}_{q} ) \} + {d}_{p} {δ}_{p r} {G}_{r q} \{ {F}_{ij} f ( x {e}_{j} , y {o}_{q} ) + {D}_{i} {δ}_{i k} {F}_{kj} f ( x {o}_{j} , y {o}_{q} ) \}$$

$$\tilde{f} ( κ {b}_{i} , λ {a}_{p} ) = {G}_{p q} \{ {F}_{ij} f ( x {e}_{j} , y {e}_{q} ) − {D}_{i} {δ}_{i k} {F}_{kj} f ( x {o}_{j} , y {e}_{q} ) \} + {d}_{p} {δ}_{p r} {G}_{r q} \{ {F}_{ij} f ( x {e}_{j} , y {o}_{q} ) − {D}_{i} {δ}_{ik} {F}_{kj} f ( x {o}_{j} , y {o}_{q} ) \}$$

$$\tilde{f} ( κ {a}_{i} , λ {b}_{p} ) = {G}_{p q} \{ {F}_{ij} f ( x {e}_{j} , y {e}_{q} ) + {D}_{i} {δ}_{i k} {F}_{kj} f ( x {o}_{j} , y {e}_{q} ) \} − {d}_{p} {δ}_{p r} {G}_{r q} \{ {F}_{ij} f ( x {e}_{j} , y {o}_{q} ) + {D}_{i} {δ}_{i k} {F}_{kj} f ( x {o}_{j} , y {o}_{q} ) \}$$

$$\tilde{f} ( κ {a}_{i} , λ {a}_{p} ) = {G}_{p q} \{ {F}_{ij} f ( x {e}_{j} , y {e}_{q} ) − {D}_{i} {δ}_{i k} {F}_{kj} f ( x {o}_{j} , y {e}_{q} ) \} − {d}_{p} {δ}_{p r} {G}_{r q} \{ {F}_{ij} f ( x {e}_{j} , y {o}_{q} ) − {D}_{i} {δ}_{i k} {F}_{kj} f ( x {o}_{j} , y {o}_{q} ) \}$$

In Equation 5, i, j, and k denote integers of 0, 1, . . . , (N/2)−1, and p, q, and r denote integers of 0, 1, . . . , (M/2)−1. In Equation 5, expressions such as δᵢₖFₖⱼ and δₚᵣG_{rq} refer to a summation convention, and expressions such as δₚᵣ and δᵢₖ refer to the Kronecker Delta.

In Equation 5, when the results of an FFT operation are output for each first and second component (κa, λa), (κb, λa), (κa, λb), (κb, λb) of each of the wave number κ and the wave number λ, each of the output results is expressed using the results of an FFT operation on each of the plurality of sub-input data sets (xe, ye), (xo, ye), (xe, yo), and (xo, yo) for the entire input.

The result of a multi-dimensional FFT operation on the first sub-input data set may be defined as EE. That is, EE refers to the result of G_{pq}Fᵢⱼf(xeⱼ, ye_{q}). EE may be referred to as a first intermediate value.

The result of a multi-dimensional FFT operation on the second sub-input data set may be defined as OE. That is, OE refers to the result of G_{pq}Fᵢⱼf(xoⱼ, ye_{q}). OE may be referred to as a second intermediate value.

The result of a multi-dimensional FFT operation on the third sub-input data set may be defined as EO. That is, EO refers to the result of G_{pq}Fᵢⱼf(xeⱼ, yo_{q}). EO may be referred to as a third intermediate value.

The result of a multi-dimensional FFT operation on the fourth sub-input data set may be defined as OO. That is, OO refers to the result of G_{pq}Fᵢⱼf(xoⱼ, yo_{q}). OO may be referred to as a fourth intermediate value.

Based on the first intermediate value, the second intermediate value, the third intermediate value, and the fourth intermediate value, a first value, a second value, a third value, and a fourth value can be defined by Equations 6 to 9 below, respectively.

$$V {1}_{ip} = {EE}_{ip} \qquad Equation 6$$

$$V {2}_{ip} = {\sum }_{k = 0}^{N / 2 - 1} {D}_{i} {δ}_{i k} 0 {E}_{kp} \qquad Equation 7$$

$$V {3}_{ip} = {\sum }_{r = 0}^{M / 2 - 1} {d}_{p} {δ}_{p r} E {0}_{i r} \qquad Equation 8$$

$$V {4}_{ip} = {\sum }_{k = 0}^{N / 2 - 1} {\sum }_{r = 0}^{M / 2 - 1} {d}_{p} {δ}_{p r} {D}_{i} {δ}_{i k} 0 {0}_{k r} \qquad Equation 9$$

In Equation 5, \tilde{f}(κaᵢ, λaₚ), \tilde{f}(κbᵢ, λaₚ), \tilde{f}(κaᵢ, λbₚ), and \tilde{f}(κbᵢ, λbₚ) can be expressed by Equations 10 to 13 below using the first value, the second value, the third value, and the fourth value, respectively.

$$\tilde{f} ( κ {a}_{i} , λ {a}_{p} ) = V {1}_{ip} + V {2}_{i p} + V {3}_{ip} + V {4}_{ip} \qquad Equation 10$$

$$\tilde{f} ( κ {b}_{i} , λ {a}_{p} ) = V {1}_{ip} - V {2}_{i p} + V {3}_{ip} - V {4}_{ip} \qquad Equation 11$$

$$\tilde{f} ( κ {a}_{i} , λ {b}_{p} ) = V {1}_{ip} + V {2}_{ip} - V {3}_{ip} - V {4}_{ip} \qquad Equation 12$$

$$\tilde{f} ( κ {b}_{i} , λ {b}_{p} ) = V {1}_{ip} - V {2}_{ip} - V {3}_{ip} + V {4}_{ip} \qquad Equation 13$$

According to an embodiment, independent and parallel pipelines can be used to calculate each of the first value V1ᵢₚ, the second value V2ᵢₚ, the third value V3ᵢₚ, and the fourth value V4ᵢₚ using the plurality of sub-input data sets. For example, a first pipeline P1 can be used to calculate the first value V1ᵢₚ from the first sub-input data set (xe, ye), a second pipeline P2 can be used to calculate the second value V2ᵢₚ from the second sub-input data set (xo, ye), a third pipeline P3 can be used to calculate the third value V3ᵢₚ from the third sub-input data set (xe, yo), and a fourth pipeline P4 can be used to calculate the fourth value V4ᵢₚ from the fourth sub-input data set (xo, yo). The pipelines each have calculation independence.

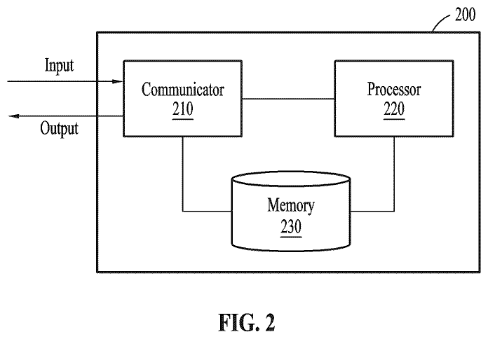

FIG. 2 illustrates a configuration of an electronic device according to an embodiment.

An electronic device 200 includes a communicator 210, a processor 220, and a memory 230. For example, the electronic device 200 may be an electronic device or a server to generate FFT values for input values.

The communicator 210 is connected to the processor 220 and the memory 230 and transmits and receives data to and from the processor 220 and the memory 230. The communicator 210 is connected to an external device and transmits and receives data to and from the external device. Hereinafter, the expression “transmitting and receiving A” refers to transmitting and receiving “information or data that indicates A.”

The communicator 210 is implemented as circuitry in the electronic device 200. For example, the communicator 210 includes an internal bus and an external bus. For another example, the communicator 210 is a component that connects the electronic device 200 to an external device. In an embodiment, the communicator 210 is an interface. The communicator 210 receives data from the external device and transmits the data to the processor 220 and the memory 230.

The processor 220 processes the data received by the communicator 210 and data stored in the memory 230. In an embodiment, the “processor” is a hardware-implemented data processing device that includes a circuit that is physically structured to execute desired operations. For example, the desired operations include code or instructions in a program. For example, the hardware-implemented data processing device is one of a microprocessor, a central processing unit (CPU), a processor core, a multi-core processor, a multiprocessor, an application-specific integrated circuit (ASIC), or a field-programmable gate array (FPGA).

The processor 220 executes computer-readable code, such as software, stored in a memory, such as the memory 230, and instructions triggered by the processor 220.

The memory 230 stores data received by the communicator 210 and data processed by the processor 220. For example, the memory 230 stores a program. an application or software. For example, the stored program is a set of instructions that are coded and executable by the processor 220 and that generate FFT values for input values.

According to an embodiment, the memory 230 is at least one of a volatile memory, a non-volatile memory, a random-access memory (RAM), flash memory, a hard disk drive, or an optical disk drive.

According to an embodiment, the memory 230 includes distributed memories.

The memory 230 stores an instruction set, such as software, that operates the electronic device 200. The instruction set that operates the electronic device 200 is executed by the processor 220.

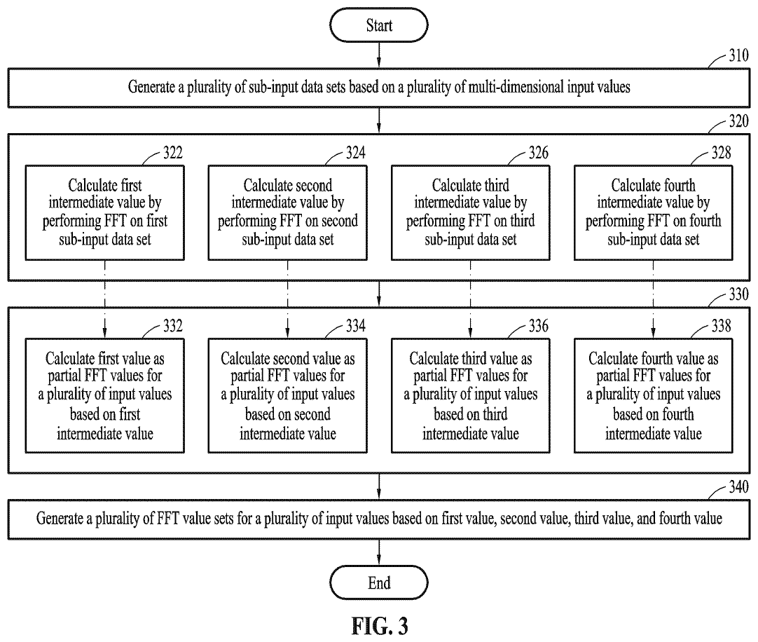

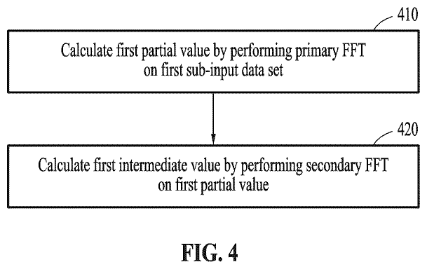

The communicator 210, the processor 220, and the memory 230 are described in detail below with reference to FIGS. 3 and 4.

FIG. 3 is a flowchart of a method of generating a plurality of FFT value sets for multi-dimensional input values, according to an embodiment.

Operations 310 to 340 are performed by the electronic device 200 described above with reference to FIG. 2.

In operation 310, the electronic device 200 generates the plurality of sub-input data sets (xe, ye), (xo, ye), (xe, yo), and (xo, yo) by classifying the plurality of input values that each have an index in the first dimension, such as the x dimension, and an index in the second dimension, such as the y dimension, based on an even index in the first dimension, an odd index in the first dimension, an even index in the second dimension, and an odd index in the second dimension. An input with an even index is an even-numbered input and an input with an odd index is an odd-numbered input.

The plurality of sub-input data sets include the first sub-input data set, such as (xe, ye), that include first input values that have an even index in the first dimension and an even index in the second dimension. The plurality of sub-input data sets include the second sub-input data set, such as (xe, yo), that include second input values that have an odd index in the first dimension and an even index in the second dimension. The plurality of sub-input data sets include the third sub-input data set, such as (xo, ye), that include third input values that have an even index in the first dimension and an odd index in the second dimension. The plurality of sub-input data sets include the fourth sub-input data set, such as (xo, yo), that include fourth input values that have an odd index in the first dimension and an odd index in the second dimension.

According to an embodiment, the first sub-input data set is processed by the first pipeline P1, the second sub-input data set is processed by the second pipeline P2, the third sub-input data set is processed by the third pipeline P3, and the fourth sub-input data set is processed by the fourth pipeline P4).

According to an embodiment, the electronic device 200 arranges the first sub-input data set in the memory 230 of the electronic device 200 through all-to-all communication in the first dimension. For example, the memory 230 includes distributed memories. The plurality of input values are stored in the distributed memories of the electronic device 200, and the memory 230 is one of the distributed memories.

In operation 320, the electronic device 200 calculates intermediate values for each of the plurality of sub-input data sets based on the plurality of sub-input data sets. Operation 320 includes operations 322, 324, 326, and 328. For example, operation 322 is performed through the first pipeline P1, operation 324 is performed through the second pipeline P2, operation 326 is performed through the third pipeline P3, and operation 328 is performed through the fourth pipeline P4.

In operation 322, the electronic device 200 calculates the first intermediate value EE by performing the FFT on the first sub-input data set through the first pipeline P1. The method of calculating the first intermediate value by performing the FFT on the first sub-input data set is expressed by Equation 5, provided above with reference to FIG. 1. The method of performing an FFT operation on the first dimension and an FFT operation on the second dimension to calculate the first intermediate value is described in detail below with reference to FIG. 4.

In operation 324, the electronic device 200 calculates the second intermediate value OE by performing the FFT on the second sub-input data set through the second pipeline P2.

In operation 326, the electronic device 200 calculates the third intermediate value EO by performing the FFT on the third sub-input data set through the third pipeline P3.

In operation 328, the electronic device 200 calculates the fourth intermediate value OO by performing the FFT on the fourth sub-input data set through the fourth pipeline P4.

In operation 330, the electronic device 200 calculates the first value, the second value, the third value, and the fourth value as partial FFT values for the plurality of input values based on the first intermediate value, the second intermediate value, the third intermediate value, and the fourth intermediate value. Operation 330 includes operations 332, 334, 336, and 338. For example, operation 332 is performed through the first pipeline P1, operation 334 is performed through the second pipeline P2, operation 336 is performed through the third pipeline P3, and operation 338 is performed through the fourth pipeline P4. The processes of calculating the first value, the second value, the third value, and the fourth value are independent from each other and correspond to an operation structure of a single instruction multiple data (SIMD).

In operation 332, the electronic device 200 calculates the first value as partial FFT values for the plurality of input values based on the first intermediate value through the first pipeline P1. The method of calculating the first value is expressed by Equation 6 provided above with reference to FIG. 1.

In operation 334, the electronic device 200 calculates the second value as partial FFT values for the plurality of input values based on the second intermediate value through the second pipeline P2. The method of calculating the second value is expressed by Equation 7 provided above with reference to FIG. 1.

In operation 336, the electronic device 200 calculates the third value as partial FFT values for the plurality of input values based on the third intermediate value through the third pipeline P3. The method of calculating the third value is expressed by Equation 8 provided above with reference to FIG. 1.

In operation 338, the electronic device 200 calculates the fourth value as partial FFT values for the plurality of input values based on the fourth intermediate value through the fourth pipeline P4. The method of calculating the fourth value is expressed by Equation 9 provided above with reference to FIG. 1.

In operation 340, the electronic device 200 generates a plurality of FFT value sets, such as \tilde{f}(κaᵢ, λaₚ), \tilde{f}(κbᵢ, λaₚ), \tilde{f}(κaᵢ, λbₚ), and \tilde{f}(κbᵢ, λbₚ), for the plurality of input values based on the first value, the second value, the third value, and the fourth value. The plurality of FFT value sets are expressed by Equations 10 to 13 described above with reference to FIG. 1. The electronic device 200 generates the plurality of FFT value sets using a diagonal matrix operation.

According to an embodiment, the electronic device 200 generates a first FFT value set by summing the first value, the second value, the third value, and the fourth value.

According to an embodiment, the electronic device 200 generates a second FFT value set by summing the first value, a negative value of the second value, the third value, and a negative value of the fourth value.

According to an embodiment, the electronic device 200 generates a third FFT value set by summing the first value, the second value, a negative value of the third value, and the negative value of the fourth value.

According to an embodiment, the electronic device 200 generates a fourth FFT value set by summing the first value, the negative value of the second value, the negative value of the third value, and the fourth value.

According to an embodiment, after operation 340 is performed, the electronic device 200 inspects a wave number for summing the plurality of FFT value sets. In the plurality of FFT value sets, the wave number λ for the second dimension includes both λa and λb, so the wave number inspection to distinguish κa and κb is performed on the wave number κ for the first dimension.

FIG. 4 is a flowchart of a method of calculating the first intermediate value for the first sub-input data set, according to an embodiment.

According to an embodiment, operations 410 and 420 correspond to operation 332 described above with reference to FIG. 3. For example, operation 332 includes operations 410 and 420.

According to an embodiment, operations 410 and 420 are performed by the electronic device 200. For example, operations 410 and 420 are performed by the processor 220 of the electronic device 200.

In operation 410, the electronic device 200 calculates a first partial value by performing a primary FFT on the first sub-input data set. For example, the electronic device 200 performs an FFT operation on the first sub-input data set in the first dimension, such as the x dimension.

According to an embodiment, the electronic device 200 arranges the calculated first partial value in the second dimension, such as the y dimension, in the memory 230 of the electronic device 200 through all-to-all communication.

In operation 420, the electronic device 200 calculates the first intermediate value by performing a secondary FFT on the first partial value. For example, the electronic device 200 performs an FFT operation on the first partial value in the second dimension, such as the y dimension.

According to an embodiment, the electronic device 200 calculates the first intermediate value by performing the secondary FFT on the first partial value arranged in the direction of the second dimension in the memory 230 of the electronic device 200.

The descriptions of operations 410 and 420 each also apply to operations 324, 326, and 328. For example, the electronic device 200 calculates a second partial value by performing the primary FFT on the second sub-input data set and calculates the second value based on the second partial value. For example, the electronic device 200 calculates a third partial value by performing the primary FFT on the third sub-input data set and calculates the third value based on the third partial value. For example, the electronic device 200 calculates a fourth partial value by performing the primary FFT on the fourth sub-input data set and calculates the fourth value based on the fourth partial value.

The flow of a method of calculating a plurality of FFT value sets for a plurality of input values using a plurality of pipelines described above with reference to FIGS. 3 and 4 can be summarized in Table 5 below.

TABLE 5
Algorithm

1: Input: f(x, y), x = {x₀, ... , x_{N-1}} = {xe, xo}, y = {y₀, ... , y_{M-1}} = {ye, yo}
2: For q = 0, ... , M/2 − 1
For i = 0, ... , N/2 − 1

| | |
|---|---|
| $Pipe 1 ; {〈 EE 〉}_{iq} ← {\sum }_{j = 0}^{N / 2 - 1} {F}_{ij} f ( {xe}_{j} , {ye}_{q} )$ | $Pipe 3 ; {〈 EO 〉}_{iq} ← {\sum }_{j = 0}^{N / 2 - 1} {F}_{ij} f ( {xe}_{j} , {yo}_{q} )$ |
| $Pipe 2 ; {〈 OE 〉}_{iq} ← {\sum }_{j = 0}^{N / 2 - 1} {F}_{ij} f ( {xo}_{j} , {ye}_{q} )$ | $Pipe 4 ; {〈 OO 〉}_{iq} ← {\sum }_{j = 0}^{N / 2 - 1} {F}_{ij} f ( {xo}_{j} , {yo}_{q} )$ |

```
    End for
    End for
3: For i = 0, ... , N/2 − 1
    For p = 0, ... , M/2 − 1
```

| | |
|---|---|
| $Pipe 1 ; ← {\sum }_{q = 0}^{M / 2 - 1} {G}_{p q} {〈 E E 〉}_{iq}$ | $Pipe 3 ; ← {\sum }_{q = 0}^{M / 2 - 1} {G}_{p q} {〈 EO 〉}_{iq}$ |
| $Pipe 2 ; ← {\sum }_{q = 0}^{M / 2 - 1} {G}_{p q} {〈 OE 〉}_{iq}$ | $Pipe 4 ; ← {\sum }_{q = 0}^{M / 2 - 1} {G}_{p q} {〈 OO 〉}_{iq}$ |

```
    End for
    End for
4: For i = 0, ... , N/2 − 1
    For p = 0, ... , M/2 − 1
```

| | |
|---|---|
| $Pipe 1 ; V {1}_{ip} =$ | $Pipe 3 ; V {3}_{ip} = {\sum }_{r = 0}^{M / 2 - 1} {d}_{p} {δ}_{pr}$ |
| $Pipe 2 ; V {2}_{ip} = {\sum }_{k = 0}^{N / 2 - 1} {D}_{i} {δ}_{ik}$ | $Pipe 4 ; V {4}_{ip} = {\sum }_{k = 0}^{N / 2 - 1} {\sum }_{r = 0}^{M / 2 - 1} {d}_{p} {δ}_{pr} {D}_{i} {δ}_{ik}$ |

```
    End for
    End for
5: For i = 0, ... , N/2 − 1
    For p = 0, ... , M/2 − 1
        \tilde{f}(κaᵢ, λaₚ) = V1ᵢₚ + V2ᵢₚ + V3ᵢₚ + V4ᵢₚ, \tilde{f}(κaᵢ, λbₚ) = V1ᵢₚ + V2ᵢₚ − V3ᵢₚ − V4ᵢₚ
        \tilde{f}(kbᵢ, λaₚ) = V1ᵢₚ − V2ᵢₚ + V3ᵢₚ − V4ᵢₚ, \tilde{f}(κbᵢ, λbₚ) = V1ᵢₚ − V2ᵢₚ − V3ᵢₚ + V4ᵢₚ
    End for
    End for
```

In Table 5, <EE>, <OE>, <EO>, and <OO> are the first partial value, the second spartial value, the third partial value, and the fourth partial value, respectively.

According to an embodiment, a two-dimensional FFT operation method described above with reference to FIGS. 3 and 4 can equally apply to a three or more dimensional FFT operation. The number of pipelines used in an FFT operation is 2^{(the number of dimensions)}, and each FFT operation that uses the pipelines corresponds to an operation structure of a SIMD. Compared to a two-dimensional FFT operation, the operations performed in each pipeline increase the number of FFT operations according to the number of dimensions, and there is no calculation dependency on other pipelines.

Methods according to above-described embodiments can be recorded in non-transitory computer-readable media that include program instructions that implement various operations of above-described embodiments. The media include, alone or in combination with the program instructions, data files, data structures, etc. The program instructions recorded on the media may be designed and constructed for the purposes of embodiments, or may be well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are configured to store and perform program instructions, such as read-only memory (ROM), random-access memory (RAM), flash memory, such as USB flash drives, memory cards, memory sticks, etc., etc. Examples of program instructions include both machine code, such as produced by a compiler, and files containing higher level code that are executed by the computer using an interpreter. The devices described above are configured to act as one or more software modules to perform the operations of embodiments, or vice versa.

The software can include a computer program, a piece of code, an instruction, or some combination thereof, to independently or collectively instruct or configure the processing device to operate as desired. Software and data can be embodied permanently or temporarily in any type of machine, component, physical or virtual equipment, computer storage medium or device, or in a propagated signal wave capable of providing instructions or data to or being interpreted by the processing device. The software can also be distributed over network coupled computer systems so that the software is stored and executed in a distributed fashion. The software and data can be stored by one or more non-transitory computer readable recording mediums.

While embodiments are described with reference to the drawings, it will be apparent to one of ordinary skill in the art that various alterations and modifications in form and details can be made in these embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Accordingly, other implementations are within the scope of the following claims.

What is claimed is:

1. A method, performed by an electronic device, of generating fast Fourier transform (FFT) values for a plurality of multi-dimensional input values, the method comprising:
generating a plurality of sub-input data sets by classifying a plurality of input values, each having an index in a first dimension and an index in a second dimension, based on an even index in the first dimension, an odd index in the first dimension, an even index in the second dimension, and an odd index in the second dimension, wherein the plurality of sub-input data sets comprises
a first sub-input data set that includes input values of the plurality of input values that have an even index in the first dimension and an even index in the second dimension,
a second sub-input data set that includes input values of the plurality of input values that have an odd index in the first dimension and an even index in the second dimension,
a third sub-input data set that includes input values of the plurality of input values that have an even index in the first dimension and an odd index in the second dimension, and
a fourth sub-input data set that includes input values of the plurality of input values that have an odd index in the first dimension and an odd index in the second dimension;
calculating a first intermediate value by performing an FFT on the first sub-input data set;
calculating a second intermediate value by performing an FFT on the second sub-input data set;
calculating a third intermediate value by performing an FFT on the third sub-input data set;
calculating a fourth intermediate value by performing an FFT on the fourth sub-input data set;
calculating a first value for the plurality of input values based on the first intermediate value;
calculating a second value for the plurality of input values based on the second intermediate value;
calculating a third value for the plurality of input values based on the third intermediate value;
calculating a fourth value for the plurality of input values based on the fourth intermediate value; and
generating a plurality of FFT value sets for the plurality of input values based on the first value, the second value, the third value, and the fourth value.

2. The method of claim 1, wherein generating the plurality of sub-input data sets comprises arranging the first sub-input data set in first dimension in a memory of the electronic device through all-to-all communication.

3. The method of claim 2, wherein
the plurality of input values is stored in a plurality of distributed memories of the electronic device, and
the memory is one of the plurality of distributed memories.

4. The method of claim 1, wherein the first intermediate value, the second intermediate value, the third intermediate value, and the fourth intermediate value are calculated through a first pipeline, a second pipeline, a third pipeline, and a fourth pipeline, respectively.

5. The method of claim 1, wherein calculating the first intermediate value by performing the FFT on the first sub-input data set comprises:
calculating a first partial value by performing a primary FFT on the first sub-input data set; and
calculating the first intermediate value by performing a secondary FFT on the first partial value.

6. The method of claim 5, wherein
calculating the first intermediate value by performing the FFT on the first sub-input data set further comprises arranging the first partial value in a second dimension in a memory of the electronic device through all-to-all communication, and
calculating the first intermediate value by performing the secondary FFT on the first partial value comprises calculating the first intermediate value by performing the secondary FFT on the first partial value arranged in the second dimension in the memory of the electronic device.

7. The method of claim 1, wherein generating the plurality of FFT value sets for the plurality of input values based on the first value, the second value, the third value, and the fourth value comprises generating a first FFT value set of the plurality of FFT value sets by summing the first value, the second value, the third value, and the fourth value.

8. The method of claim 1, wherein generating the plurality of FFT value sets for the plurality of input values based on the first value, the second value, the third value, and the fourth value comprises generating a second FFT value set of the plurality of FFT value sets by summing the first value, a negative value of the second value, the third value, and a negative value of the fourth value.

9. The method of claim 1, wherein generating of plurality of FFT value sets for the plurality of input values based on the first value, the second value, the third value, and the fourth value comprises generating a third FFT value set of the plurality of FFT value sets by summing the first value, the second value, a negative value of the third value, and a negative value of the fourth value.

10. The method of claim 1, wherein generating the plurality of FFT value sets for the plurality of input values based on the first value, the second value, the third value, and the fourth value comprises generating a fourth FFT value set of the plurality of FFT value sets by summing the first value, a negative value of the second value, a negative value of the third value, and the fourth value.

11. A non-transitory computer-readable storage medium storing instructions that, when executed by a processor, causes the processor to perform the method of claim 1.

12. An electronic device, comprising:
a processor; and
a memory,
wherein the processor is configured to:
generate a plurality of sub-input data sets by classifying a plurality of input values, each having an index in a first dimension and an index in a second dimension, based on an even index in the first dimension, an odd index in the first dimension, an even index in the second dimension, and an odd index in the second dimension, wherein the plurality of sub-input data sets comprises
a first sub-input data set that includes input values of the plurality of input values that have an even index in the first dimension and an even index in the second dimension,
a second sub-input data set that includes input values of the plurality of input values that have an odd index in the first dimension and an even index in the second dimension,
a third sub-input data set that includes input values of the plurality of input values that have an even index in the first dimension and an odd index in the second dimension, and
a fourth sub-input data set that includes input values of the plurality of input values that have an odd index in the first dimension and an odd index in the second dimension;
calculate a first intermediate value by performing an FFT on the first sub-input data set;
calculate a second intermediate value by performing an FFT on the second sub-input data set;
calculate a third intermediate value by performing an FFT on the third sub-input data set;
calculate a fourth intermediate value by performing an FFT on the fourth sub-input data set;
calculate a first value, a second value, a third value, and a fourth value for the plurality of input values based on the first intermediate value, the second intermediate value, the third intermediate value, and the fourth intermediate value; and
generate a plurality of FFT value sets for the plurality of input values based on the first value, the second value, the third value, and the fourth value.

13. The electronic device of claim 12, wherein the processor is configured to arrange the first sub-input data set in the first dimension in the memory of the electronic device through all-to-all communication.

14. The electronic device of claim 13, wherein
the memory is one of a plurality of distributed memories, and
the plurality of input values is stored in the plurality of distributed memories of the electronic device.

15. The electronic device of claim 12, wherein the processor is configured to:
calculate a first partial value by performing a primary FFT on the first sub-input data set; and
calculate the first intermediate value by performing a secondary FFT on the first partial value.

16. The electronic device of claim 15, wherein the processor is further configured to:
arrange the first partial value in the second dimension in the memory of the electronic device through all-to-all communication; and
calculate the first intermediate value by performing the secondary FFT on the first partial value arranged in the second dimension in the memory of the electronic device.

17. The electronic device of claim 12, wherein the processor is configured to generate a first FFT value set of the plurality of FFT value sets by summing the first value, the second value, the third value, and the fourth value.

18. The electronic device of claim 12, wherein the processor is configured to generate a second FFT value set of the plurality of FFT value sets by summing the first value, a negative value of the second value, the third value, and a negative value of the fourth value.

19. A method, performed by an electronic device, of generating fast Fourier transform (FFT) values for a plurality of multi-dimensional input values, the method comprising:
generating a plurality of sub-input data sets by classifying a plurality of input values, each having an index in a first dimension and an index in a second dimension, based on an even index in the first dimension, an odd index in the first dimension, an even index in the second dimension, and an odd index in the second dimension, wherein the plurality of sub-input data sets comprises a first sub-input data set, a second sub-input data set, a third sub-input data set, and a fourth sub-input data set;
calculating a first intermediate value by performing an FFT on the first sub-input data set;
calculating a second intermediate value by performing an FFT on the second sub-input data set;
calculating a third intermediate value by performing an FFT on the third sub-input data set;
calculating a fourth intermediate value by performing an FFT on the fourth sub-input data set;
calculating a first value for the plurality of input values based on the first intermediate value;
calculating a second value for the plurality of input values based on the second intermediate value;
calculating a third value for the plurality of input values based on the third intermediate value;
calculating a fourth value for the plurality of input values based on the fourth intermediate value; and
generating a plurality of FFT value sets for the plurality of input values based on the first value, the second value, the third value, and the fourth value,
wherein the first intermediate value, the second intermediate value, the third intermediate value, and the fourth intermediate value are calculated through a first pipeline, a second pipeline, a third pipeline, and a fourth pipeline, respectively.

20. The method of claim 19, wherein
the first sub-input data set includes input values of the plurality of input values that have an even index in the first dimension and an even index in the second dimension,
the second sub-input data set includes input values of the plurality of input values that have an odd index in the first dimension and an even index in the second dimension,
the third sub-input data set includes input values of the plurality of input values that have an even index in the first dimension and an odd index in the second dimension, and
the fourth sub-input data set includes input values of the plurality of input values that have an odd index in the first dimension and an odd index in the second dimension.
